(19) United States
(12) Patent Application Publication
(10) Pub. No.: US 2024/0146524 A1
(43) Pub. Date: May 2, 2024

(54) EDGE VIDEO STREAM ENCODING WITH ENCRYPTING OF CONFIDENTIAL CONTENT

(71) Applicant: INTERNATIONAL BUSINESS MACHINES CORPORATION, Armonk, NY (US)

(72) Inventors: Bin XU, Beijing (CN); Guang Han SUI, Beijing (CN); Jing LI, Beijing (CN); Lin DONG, Beijing (CN)

(21) Appl. No.: 18/050,116

(22) Filed: Oct. 27, 2022

(51) Int. Cl. H04L 9/08; H04N 21/2347

(52) U.S. Cl. CPC H04L 9/088; H04N 21/23476

(57) ABSTRACT

Edge device video processing with encryption of confidential image content is provided. The process includes obtaining, by the edge device, a video stream, and partitioning image content of the video stream into a confidential part and a non-confidential part. Further, the process includes encrypting, by the edge device, the confidential part of the image content to obtain encrypted image content from the confidential part and non-encrypted image content from the non-confidential part of the image content. In addition, the process includes encoding, by the edge device, the encrypted image content and the non-encrypted image content into an encoded video stream, and transmitting the encoded video stream to one or more processing servers.

### BACKGROUND

One or more aspects relate, in general, to edge computing, and more particularly, to enhanced edge device encoding of a video stream.

In a cloud environment, edge computing (i.e., computing at or near a boundary) enables processing and/or storage of data to be provided closer to the device(s) where operations are being performed. Accordingly, edge computing can eliminate the need for data to be processed or stored being transmitted to a central location (e.g., a central cloud server), which may be physically located a significant distance from the device(s). Although this configuration may not provide a substantial change to the services being provided from an individual device perspective, the large increase of Internet of Things (IoT), and other electronic devices, including mobile devices, exponentially increases network requirements when utilizing cloud services, which can cause an increase in latency, potentially resulting in lower quality of service, higher bandwidth costs, etc. Advantageously, edge computing can assist in alleviating these issues.

Computer vision is a field of artificial intelligence (AI) that processes a video stream from one or more cameras, video recorders, etc., using deep learning models to accurately identify and classify objects in the video stream. Computer vision is used in a variety of applications, such as for auto-driving, auto-parking, product-line auto-control, etc.

### SUMMARY

Certain shortcomings of the prior art are overcome, and advantages are provided through the provision, in one or more aspects, of a computer-implemented method which includes obtaining, by an edge device, a video stream, and partitioning, by the edge device image content of the video stream into a confidential part and a non-confidential part. The computer-implemented method further includes encrypting, by the edge the device, the confidential part of the image content to obtain encrypted image content from the confidential part and non-encrypted image content from the non-confidential part of the image content. In addition, the computer-implemented method includes encoding, by the edge device, the encrypted image content and the non-encrypted image content into an encoded video stream, and transmitting, by the edge device, the encoded video stream to one or more processing servers.

Computer systems and computer program products relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to include and/or use one or more aspects of the present invention;

FIG. 2 depicts another example of a computing environment to incorporate and/or use one or more aspects of the present invention;

FIG. 3 depicts one embodiment of an edge video stream workflow, in accordance with one or more aspects of the present invention;

FIG. 4A depicts an example of edge video stream processing, in accordance with one or more aspects of the present invention;

FIG. 4B depicts one embodiment of intra-frame compression by an autoencoder, such as the autoencoder of the edge video stream processing of FIG. 4A, in accordance with one or more aspects of the present invention;

FIG. 4C depicts one embodiment of inter-frame compression in a video encode process, such as the inter-frame compression in the edge video stream processing of FIG. 4A, in accordance with one or more aspects of the present invention;

FIG. 5 depicts one embodiment of image content reconstruction at a processing server using both decode and decrypt modules available to the processing server, in accordance with one or more aspects of the present invention; and

FIG. 6 depicts another embodiment of a computing environment to include and/or use one or more aspects of the present invention.

### DETAILED DESCRIPTION

The accompanying figures, which are incorporated in and form a part of this specification, further illustrate the present invention and, together with this detailed description of the invention, serve to explain aspects of the present invention. Note in this regard that descriptions of well-known systems, devices, processing techniques, etc., are omitted so as to not unnecessarily obscure the invention in detail. It should be understood, however, that the detailed description and this specific example(s), while indicating aspects of the invention, are given by way of illustration only, and not limitation. Various substitutions, modifications, additions, and/or other arrangements, within the spirit or scope of the underlying inventive concepts will be apparent to those skilled in the art from this disclosure. Note further that numerous inventive aspects or features are disclosed herein, and unless inconsistent, each disclosed aspect or feature is combinable with any other disclosed aspect or feature as desired for a particular application of the concepts disclosed.

Note also that illustrative embodiments are described below using specific code, designs, architectures, protocols, layouts, schematics, or tools only as examples, and not by way of limitation. Furthermore, the illustrative embodiments are described in certain instances using particular software, hardware, tools, or data processing environments only as example for clarity of description. The illustrative embodiments can be used in conjunction with other comparable or similarly purposed structures, systems, applications, or architectures. One or more aspects of an illustrative embodiment can be implemented in software, hardware, or a combination thereof.

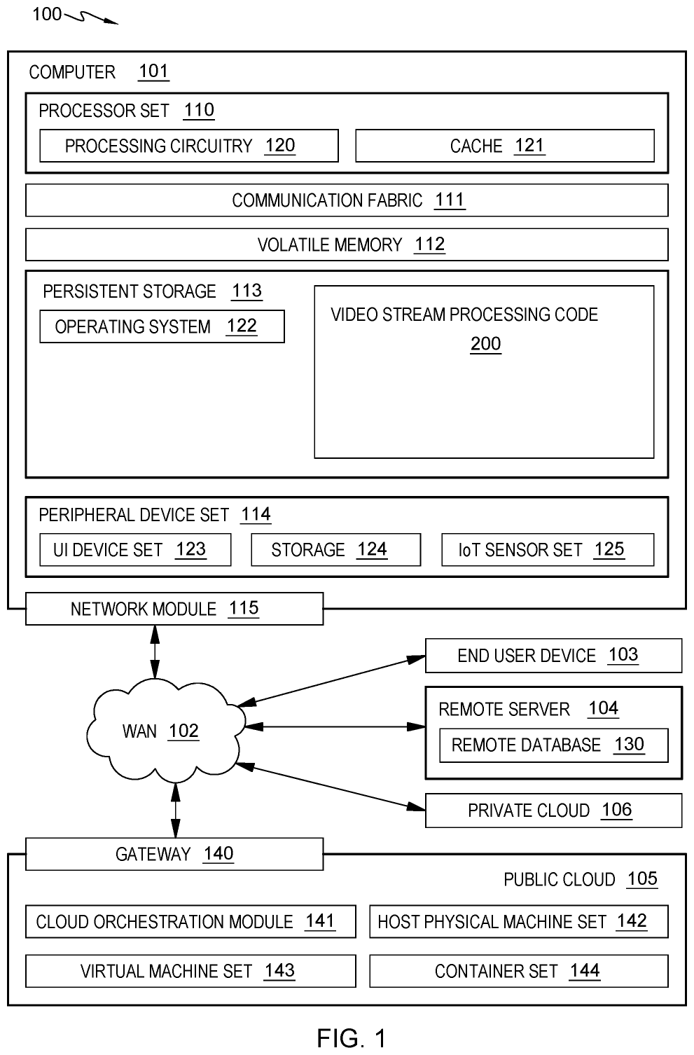

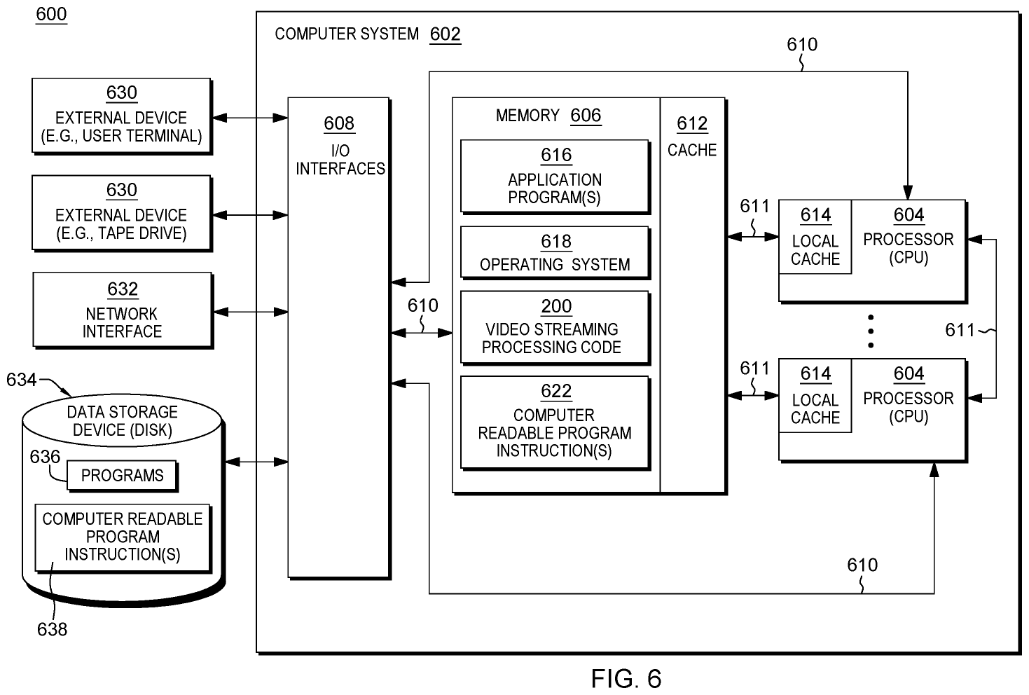

As understood by one skilled in the art, program code, as referred to in this application, can include software and/or hardware. For example, program code in certain embodiments of the present invention can utilize a software-based implementation of the functions described, while other embodiments can include fixed function hardware. Certain embodiments combine both types of program code. Examples of program code, also referred to as one or more programs, are depicted in FIG. 1 as operating system 122 and video stream processing code 200, which are stored in persistent storage 113. In another example, program code depicted in the computing environment of FIG. 6 includes, in part, application program(s) 616, operating system 618, video stream processing code 200, and computer-readable program instruction(s) 622, which are stored in memory 606 of computer system 602. Note that although shown separately in FIG. 6, video stream processing code 200 could be, in one or more other embodiments, associated with or part of application program(s) 616 and/or computer-readable program instruction(s) 622.

Prior to describing embodiments of the present invention, an example of a computing environment to include and/or use one or more aspects of the present invention is discussed below with reference to FIG. 1.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as video stream processing code block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 126 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As noted, computer vision is a field of artificial intelligence (AI) that processes a video stream from, for instance, one or more cameras, video recorders, etc., using deep learning models to accurately identify and classify objects in the video stream. Video processing, such as computer vision, is used in a variety of applications, such as for auto-driving, auto-parking, product-line auto-control, etc. Computer vision can be widely used in association with edge computing. With the adoption of AI video processing, however, edge computing cannot typically accommodate all of the deep learning tasks of many computer vision applications, and depending on the application, video stream data still needs to be processed remotely, such as, for instance, by cloud-based processing. Within this context, provided herein are computer-implemented methods, computer systems and computer program products which facilitate artificial intelligence-based processing of a video stream, including AI-based edge processing of a video stream by an edge device of a computing environment.

In one or more embodiments, the computer-implemented method includes obtaining, by an edge device, a video stream, and partitioning, by the edge device, image content of the video stream into a confidential part and a non-confidential part. In addition, the method includes encrypting, by the edge device, the confidential part of the image content to obtain encrypted image content from the confidential part and non-encrypted image content from the non-confidential part of the image content. Further, the computer-implemented method includes encoding, by the edge device, the encrypted image content and the non-encrypted image content into an encoded video stream, and transmitting, by the edge device, the encoded video stream to one or more processing servers, such as one or more cloud-based processing servers, for further processing and/or analysis.

Advantageously, in one or more aspects, the computer-implemented methods, computer systems and computer program products disclosed herein provide enhanced edge video stream processing with a focus on protecting confidential image content, while optimizing video transmission from the edge device to one or more processing servers using, for instance, an autoencoder. The edge video stream processing disclosed is addressed, in one or more aspects, to identifying confidential objects and encrypting the confidential objects within the image data, while leaving non-confidential objects unencrypted. In one or more embodiments, a confidentiality-enforced, generative autoencoder framework is presented, to encode and/or decode a video stream, and use the framework to build a secure edge video analytics method and system. In one or more implementations, selective, confidential image content encryption is provided, which allows a decoded video to contain different levels of confidential information. Further in one or more embodiments, the encoded video stream can be transmitted as a multicast stream to multiple servers, with different security levels, such that different servers (or different clients) can decrypt the encrypted image content to obtain different levels of confidential image content.

In one or more implementations, the edge device includes a machine learning-based partitioning layer to partition the image content of the video stream into the confidential part and the non-confidential part based, for instance, on identifying one or more confidential objects in the image content of the video stream. In one example, one or more confidential objects of the image content of the video stream can be masked (e.g., blocked, overlaid, removed, etc.) to produce the non-encrypted image content using the non-confidential part of the image content.

In one or more embodiments, transmitting the encoded video stream can include multicasting, by the edge device, the encoded video stream to multiple processing servers with different access rights to the encrypted image content of the encoded video stream. In one or more implementations, the encrypting includes separating the confidential part of the image content into multiple levels of confidential content, and separately encrypting the multiple levels of confidential content using different confidential-level encryption keys to obtain multiple levels of confidential encrypted image content. In one example, the multiple processing servers with different access rights to the encrypted image content of the encoded video stream have different keys, each to decrypt a respective level of encrypted confidential content in the encoded video stream.

In one or more embodiments, the edge device includes one or more encode layers of an autoencoder, where the encoding by the device being performed by the one or more encode layers of the autoencoder to provide a single encoded video stream from the encrypted image content and the non-encrypted image content. In one or more implementations, a processing server of the one or more processing servers includes one or more decode layers of the autoencoder to facilitate reconstructing at least the non-encrypted image content of the single encoded video stream.

In one or more embodiments, the encoding includes using, by the edge device, lossy video compression to encode the encrypted image content and the non-encrypted image content into the encoded video stream.

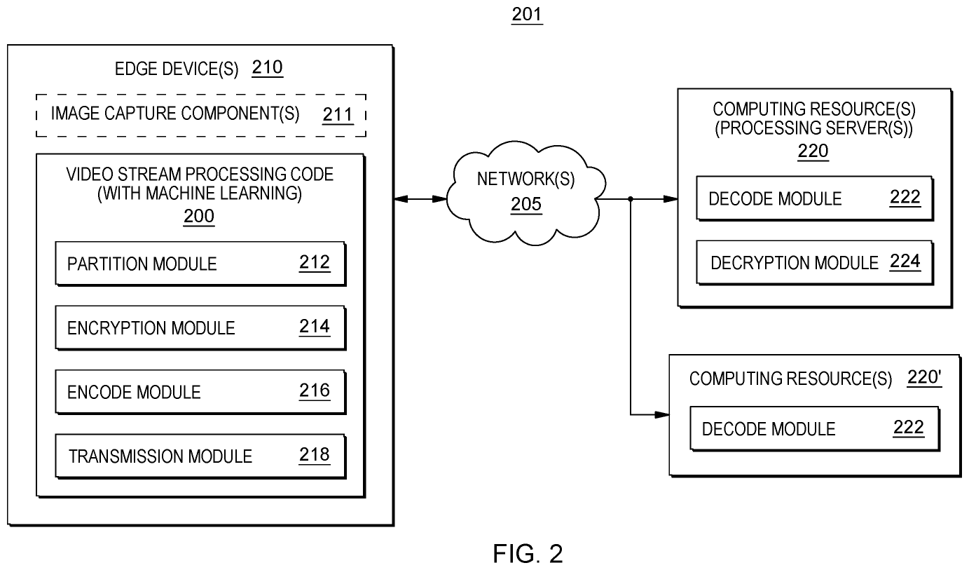

FIG. 2 depicts another embodiment of a technical environment or system 201, into which various aspects of some embodiments of the present invention can be implemented. System 201 includes, by way of example, one or more edge devices 210 that execute program code, such as video stream processing code 200, and which include, or have associated therewith, one or more image capture components 211 to facilitate obtaining, by an edge device, a video stream. Note that in an alternate embodiment, the edge device can be configured to receive the video stream and/or image content from another device, such as a camera, video recorder, security monitor, etc., coupled to the edge device. Additionally, in the depicted embodiment, system 201 includes one or more computing resources 220, 220′ (or processing servers) that execute program code, such as a decode module 222 and/or decryption module 224 for decoding and decrypting an encoded video stream received across one or more networks 205 from edge device(s) 210. By way of example, network(s) 205 can be, or include, for instance, a telecommunications network, a local-area network (LAN), a wide-area network (WAN), such as the Internet, or a combination thereof, and can include wired, wireless, fiber-optic connections, etc. The network(s) can include one or more wired and/or wireless networks that are capable of receiving and transmitting data, including encoded video stream data such as described herein. In one or more implementations, network(s) 205 can utilize any communication protocol that allows data to be transferred between components of system 201 (e.g., one or more wireless interconnection standards, Wi-Fi, cellular (e.g., 3G, 4G, 5G), Ethernet, etc.).

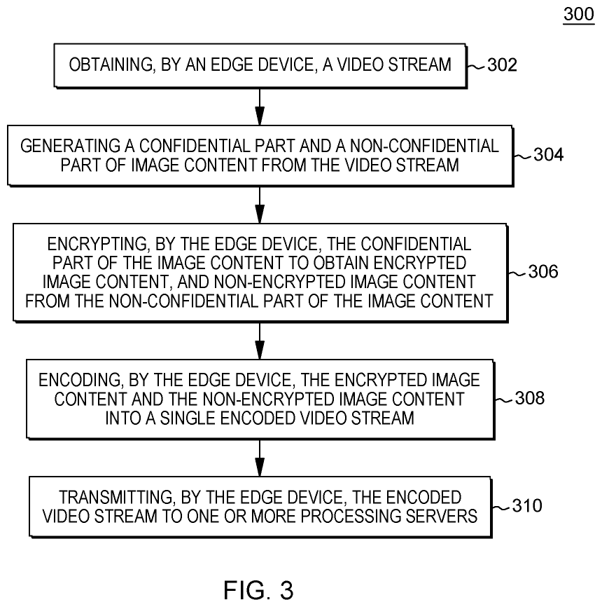

As illustrated in FIG. 2, edge device(s) 210 includes an embodiment of video stream processing code 200. Note that one or more aspects of video stream processing code 200 can include machine learning, such as one or more aspects of the deep machine learning models discussed herein. By way of example, video stream processing code 200 includes (in one embodiment) a partition module 212, an encryption module 214, an encode module 216, and a transmission module 218. One or more of the modules includes code or instructions used to perform processing described herein, in accordance with one or more aspects of the present invention. The modules are, e.g., computer-readable program code (e.g., instructions) and computer-readable media, e.g., persistent storage (e.g., persistent storage 113 of FIG. 1, such as a disk), and/or a cache (e.g., cache 121 of FIG. 1), as examples. The computer-readable media can be part of a computer program product, and can be executed by and/or used by one or more computers, such as computer(s) 101; processors, such as a processor of processor set 110, and/or processing circuitry, such as processing circuitry of processor set 110 and/or processing circuitry of an edge device, etc. One example of edge video stream processing is described further below with reference to FIG. 3.

In one or more aspects, partition module 212 includes program code for partitioning, by the edge device, image content of a video stream into a confidential part and a non-confidential part. As described herein, partition module 212 can include one or more machine-learning-based partition layers which operate to identify one or more specified confidential objects in the image content of a video stream. In this manner, a confidential part of the image stream can be encrypted, while the non-confidential part can remain unencrypted image content. By way of example, partition module 212 can implement confidential object recognition to identify any specified confidential objects or images in a video stream. Object recognition is a key output of deep learning in many machine learning algorithms.

Encryption module 214 can utilize a variety of encryption techniques to selectively encrypt only the confidential part or object(s) of the image content from the video stream. For instance, in one or more embodiments, one or more specified confidential objects are identified by the partitioning module, which can be encrypted using an encryption/decryption key that is also available at one or more computing resources (or processing servers) 200 to facilitate decryption by a decryption module 224 of encrypted image content in a received encoded video stream.

In one or more embodiments, encode module 216 can include program code to encode the encrypted image content and non-encrypted image content into an encoded video stream using, for instance, an autoencoder, such as one or more encode layers of an autoencoder machine learning model, with decode module 222 including one or more decode layers of the autoencoder machine learning model. As understood in the art, an autoencoder is an unsupervised artificial neural network that learns how to efficiently compress and encode data, such as the encrypted image content and non-encrypted image content discussed herein, and learns how to reconstruct the data back from the reduced encoded representation as close to the original input as possible. Advantageously, an autoencoder can reduce data dimensions by learning how to ignore noise in the data.

In one or more embodiments, video stream processing code 200 further includes a transmission module 218 to facilitate transmitting, by the edge device, the encoded video stream to one or more processing servers or computing resources 220, 220′. In one or more implementations, the transmitting can be via multicasting of the encoded video stream to multiple remote processing servers, such as multiple remote cloud-based processing servers, which may perform different tasks or functions using the encoded video stream. By way of example, in one implementation, computing resource(s) 220 can decode the encoded video stream to obtain the encrypted image content and non-encrypted image content with, for instance, the encrypted image content being masked in the non-encrypted image content, and then decrypt the encrypted image content via decryption module 224 to obtain both the confidential part and non-confidential part of the image content, while computing resource(s) 220′ can decode the encoded video stream via decode module 222 to obtain the non-encrypted image content of the video stream, with the encrypted image content remaining masked or otherwise obscured, in one or more implementations. This advantageously allows the encoded video stream to be transmitted to multiple processing servers with different access rights to the encrypted image content of the encoded video stream. For instance, in one or more embodiments, processing server 220′ may only need access to the non-confidential part of the image content to perform one or more desired analytics on the video stream, while one or more other processing servers may need access to both the non-confidential part of the image content and the confidential part in order to perform different analytics on the video stream.

Additionally, in one or more implementations, video stream processing code 200 such as described herein uses, at least in part, artificial intelligence (AI) with, for instance, one or more machine learning models. For instance, in one or more implementations, one or more aspects of partition module 212 and/or encode module 216 can utilize machine learning to facilitate the functions described. In one or more embodiments, the modules can include or use one or more machine learning agents and one or more machine learning models trained for the applicable function. For instance, in one implementation, partition module 212 includes a machine learning model to facilitate identifying one or more specified confidential objects of the image content of a video stream to partition for encrypting the confidential part (or objects) without encrypting the non-confidential part of the image data. In another example, encode module 216 can include one or more machine learning models trained to facilitate, for instance, intra-frame autoencoding at one or more edge devices 210 paired with one or more processing servers 220, 220′. In one or more implementations, the processing server(s) 220, 220′ can also implement artificial intelligence (AI) or machine learning to, for instance, further analyze the image content of the video stream once decoded and/or decrypted, depending on the application.

The machine-learning models can be trained using training data that can include a variety of types of data, depending on the model and the data sources. In one or more embodiments, program code executing on one or more edge devices or computing resources applies machine-learning algorithms of a machine-learning agent to generate and train the model(s), which the program code then utilizes to, for instance, partition image content of a video stream into a confidential part and a non-confidential part, encode encrypted image content and non-encrypted image content into an encoded video stream, etc., and depending on the application, to further perform an action (e.g., provide a solution, make a recommendation, perform a task, etc.). In an initialization or learning stage, program code trains one or more machine-learning models using obtained training data that can include, in one or more embodiments, specified confidential object data, as well artificial neural network data used to learn efficient coding of unlabeled data (unsupervised learning), such as described herein.

Training data used to train a model (in one or more embodiments of the present invention) can include a variety of types of data, such as data generated by, or received at, the edge device(s) and/or data stored in one or more databases of, or accessible by, the edge device(s) or computing resource(s). Program code, in embodiments of the present invention, can perform machine-learning analysis to generate data structures, including algorithms utilized by the program code to predict and/or perform a machine-learning action. As known, machine-learning (ML) solves problems that cannot be solved by numerical means alone. In this ML-based example, program code extract features/attributes from training data, which can be stored in memory or one or more databases. The extracted features are utilized to develop a predictor function, h(x), also referred to as a hypothesis, which the program code utilizes as a machine-learning model. In identifying a machine-learning model, various techniques can be used to select features (elements, patterns, attributes, etc.), including but not limited to, diffusion mapping, principal component analysis, recursive feature elimination (a brute force approach to selecting features), and/or a random forest, to select the attributes related to the particular model. Program code can utilize a machine-learning algorithm to train machine-learning model (e.g., the algorithms utilized by program code), including providing weights for conclusions, so that the program code can train any predictor or performance functions included in the machine-learning model. The conclusions can be evaluated by a quality metric. By selecting a diverse set of training data, the program code trains the machine-learning model to identify and weight various attributes (e.g., features, patterns) that correlate to enhanced performance of the machine-learned model.

In one or more embodiments, program code of the present invention can utilize and/or tie together multiple existing artificial intelligence (AI) applications.

In one or more embodiments of the present invention, the program code can utilize a neural network to analyze training data and/or collected data to generate an operational machine-learning model. Neural networks are a programming paradigm which enable a computer to learn from observational data. This learning is referred to as deep learning, which is a set of techniques for learning in neural networks. Neural networks, including modular neural networks, are capable of pattern (e.g., state) recognition with speed, accuracy, and efficiency, in situations where datasets are mutual and expansive, including across a distributed network, including but not limited to, cloud computing systems. Modern neural networks are non-linear statistical data modeling tools. They are usually used to model complex relationships between inputs and outputs, or to identify patterns (e.g., states) in data (i.e., neural networks are non-linear statistical data modeling or decision-making tools). In general, program code utilizing neural networks can model complex relationships between inputs and outputs and identified patterns in data. Because of the speed and efficiency of neural networks, especially when parsing multiple complex datasets, neural networks and deep learning provide solutions to many problems in multi-source processing, which program code, in embodiments of the present invention, can utilize in implementing a machine-learning model, such as described herein.

FIG. 3 depicts one embodiment of an edge video steam workflow or process 300, in accordance with one or more aspects of the present invention. In the embodiment depicted, the edge video stream processing includes obtaining, by an edge device, a video stream 302. In one or more implementations, the edge device can capture the video stream itself, and/or receive the video stream from one or more video or image capture components associated with or in communication with the edge device. The process further includes generating a confidential part and a non-confidential part of image content from the video stream 304. In one embodiment, this can include utilizing an object recognition component of a machine learning algorithm configured to look for or identify one or more specified confidential objects in the video stream. By identifying one or more confidential objects, the processing inherently partitions the image content of the video stream into a confidential part and a non-confidential part, with the non-confidential part including all the image data other than the confidential part, in one example.

As illustrated in FIG. 3, the process further includes encrypting, by the edge device, the confidential part of the image content to obtain encrypted image content, and non-encrypted image content, from the non-confidential part of the image content 306. Any of a variety of available key-based encryption techniques can be used to encrypt the confidential part of the image content, as desired for a particular application.

Further, the process includes encoding, by the edge device, the encrypted image content and the non-encrypted image content into a single encoded video stream 308. In one embodiment, the encoding can use one or more encode layers of an autoencoder, where the edge device is paired via the autoencoder with one or more processing servers (or remote computer resources). As illustrated, the edge device transmits the encoded video stream to the one or more processing servers 310 to, in one or more embodiments, facilitate further machine learning-based analysis of the image content of the video stream for one or more applications.

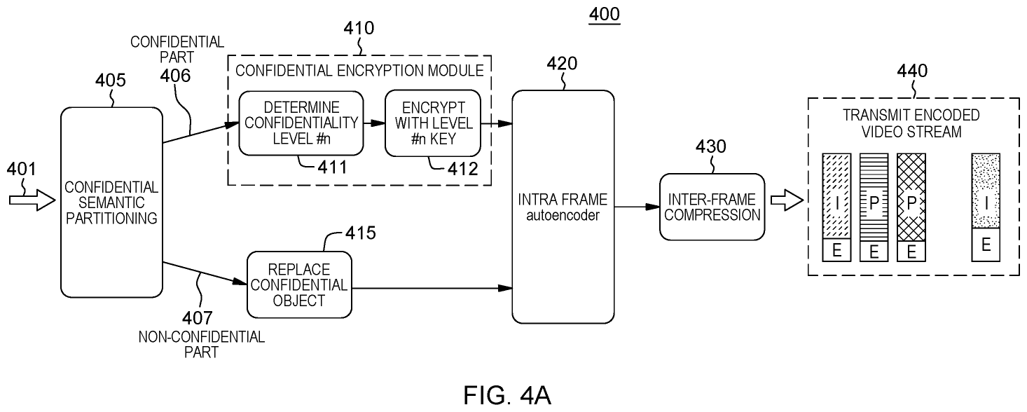

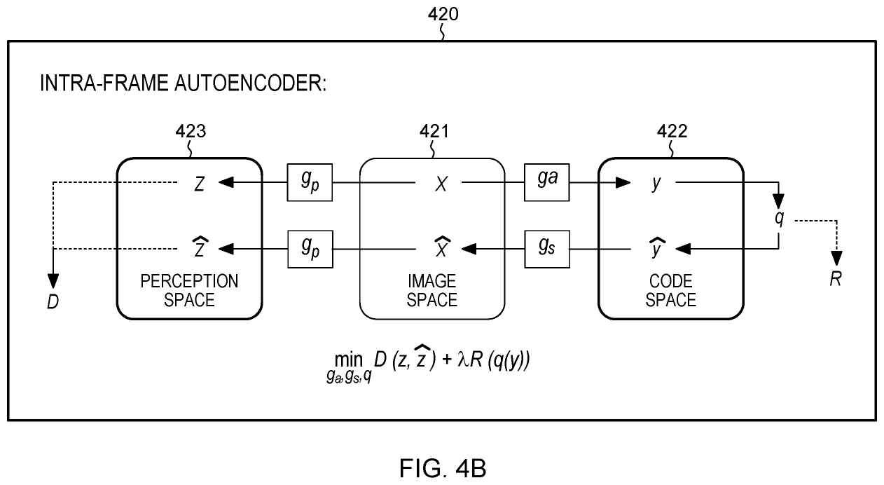

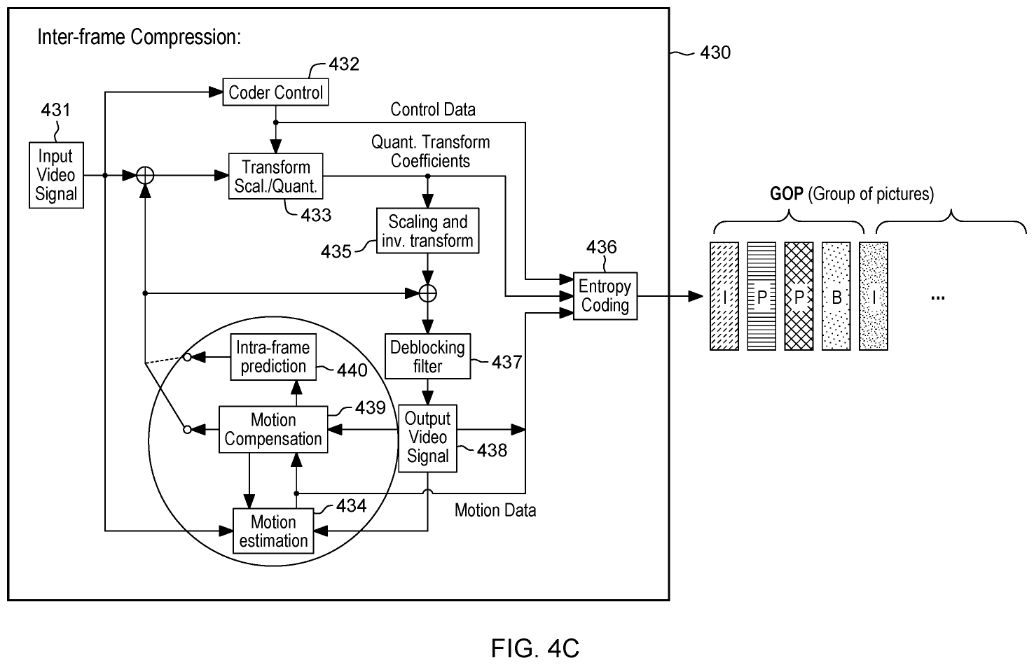

One embodiment of edge video stream encoding with encrypting of confidential content such as described herein is depicted in FIGS. 4A-4C.

Referring initially to FIG. 4A, one embodiment of an edge device 400, similar to edge device 210 described above in connection with FIGS. 1 & 2, is depicted. As illustrated, a video stream 401 is obtained by edge device 400, and initially evaluated by a machine learning-based partitioning module, such as a confidential semantic partitioning module 405, to identify whether the image content contains a confidential part, and if so, the image content of the video stream is partitioned into the confidential part 406 and a non-confidential part 407, with the confidential part being forwarded to undergo encryption at a confidential encryption module 410 of the edge device. Note that, in one or more embodiments, the confidential semantic partitioning can distinguish between different levels of confidential objects. When multi-level-based partitioning is implemented, the different levels of confidential objects can be encrypted by determining a confidentiality level n 411 for a particular confidential object, and then encrypting the object to that confidentiality level using a corresponding confidentiality-level encryption key 412. As illustrated, the non-confidential part 407 of the image content can be isolated by masking 415 (replacing, overlaying, etc.) the confidential part of the image content so that only the non-confidential part remains unmasked and unencrypted.

In the embodiment illustrated, an intra-frame autoencoder 420 is used to encode, by the edge device, the resultant encrypted image content and non-encrypted image content of the image frames. In one embodiment, the autoencoder is an unsupervised artificial neural network capable of learning how to efficiently compress and encode data, as well as how to reconstruct the data back from the reduced encoded representation. Once intra-frame encoded, inter-frame compression 430 is performed to obtain a group of pictures where confidential content has been encrypted (E) and included as part of the single encoded video stream to be transmitted 440 from the edge device.

FIG. 4B depicts one example of image encoding/decoding using an autoencoder, such as discussed herein. As illustrated, an original image x is transformed by an analysis function gₐ to achieve code y. Code y is quantized (denoted by q) and compressed into bits. The number of bits is used to measure the coding rate (R). The quantized code ŷ is then inversely transformed by a synthesis function gₛ to achieve the reconstructed image \hat{x}. Both x and \hat{x} are further transformed by a same perceptual function gₚ, resulting in z and \hat{z}, respectively. The difference between z and \hat{z} is then used to measure the distortion (D). After inter-frame encoding by the autoencoder, inter-frame compression 430 occurs, as illustrated in FIG. 4A, with the resultant encoded video stream including groups of pictures with confidential content encrypted (E) for protection during transmission and at the receiver, that is, where the receiver is unauthorized to decrypt the content (e.g., does not possess the encryption/decryption key needed to decrypt the encrypted image content). Note that inter-frame compression approaches typically use three primary concepts. An I-frame, which is a fully encoded image, where every I-frame contains all data needed to represent that image, a P-frame, which is a predicted frame based on the image change from a prior I-frame, and a B-frame, which is a bidirectionally predicted frame, using data from a last P-frame, and a next I-frame.

FIG. 4C depicts one example of an inter-frame compression 430, which can be used in edge video stream encoding such as described herein. As known, inter-frame compression uses inter-frame prediction between neighboring frames of a video stream to take advantage of, for instance, temporal redundancy between neighboring frames, enabling enhanced compression performance. In the inter-frame compression 430 embodiment of FIG. 4C, an input video signal 431 from, for instance, intra-frame autoencoder 420 of FIGS. 4A-4B, is received by a coder control 432, a transform scaler/quantizer 433, and motion estimation 434. Transform scaler/quantizer 433 arranges the video signal into a suitable format for subsequent lossy coding operations. Motion estimation 434 estimates, in one embodiment, object motion between neighboring frames, and outputs motion data as part of the entropy coding 436. Additionally, control data and quantized transform coefficients are provided as part of the entropy coding, such as an encoded inter-frame sub-block or encoded inter-frame prediction error and motion vector, in one or more embodiments. Scaling and inverse transformation 435 and a deblocking filter 437 can be included which provide the output video signal 438, for example, for motion compensation 439 and intra-frame prediction 440. Motion compensation 437 makes use of the current frame motion estimates and previously reconstructed frame to generate the current frame prediction 440. FIG. 4C illustrates transmission for, for instance, further analytics of, I, P, and B frames, in one embodiment. Note that FIGS. 4B & 4C are depicted and described herein by way of example only. There are a variety of video compression approaches or standards which can be employed in association with edge video stream encoding with encryption of confidential content, such as described herein.

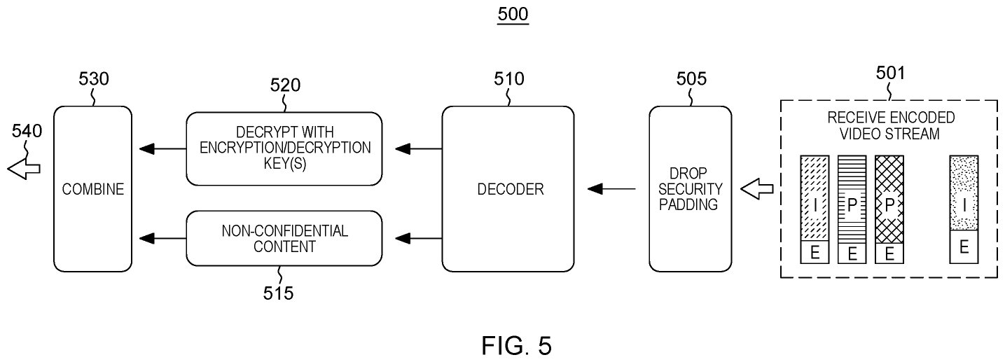

As illustrated in FIG. 5, in accordance with one or more aspects, a computing resource or processing server 500 receives an encoded video stream 501 which has encrypted image content (E), meaning that a confidential part of the image data has been encrypted, and also masked or transformed in the non-confidential part of the image data during intra-frame and inter-frame compression. At a remote computing resource (or processing server) 500, such as the computing resource(s) or processing server of FIGS. 1-2, the received encoded video stream is to undergo video reconstructing, where the non-encrypted image content is decoded as normal, and the encrypted image content can only be decrypted using an appropriate decryption key. As illustrated in FIG. 5, the received encoded video stream 501 is reconstructed, in one embodiment, by dropping any security padding or encryption padding 505, and passing the video stream to a decode module 510, such as decode module 222 of FIG. 2. In one embodiment, decode module 510 includes one more decode layers of the autoencoder, such that the receiving computing resource(s) or processing server is paired with the edge device sending the encoded video stream. Decoder 510 decodes both the encrypted image content and the non-encrypted image content. The encrypted image content is then decrypted with the appropriate encryption/decryption level key 520 and combined 530 with the non-confidential content 515 to obtain the final, reconstructed image 540, which can then undergo further analytics, depending on the application at the remote computer resource(s) or processing server.

Advantageously, the edge video stream processing described herein works well with lossy video compression. The encoded video stream transmitted by the edge device is very compressed, meaning that there is less likelihood of a bottleneck at an edge device with low-bandwidth connection to the network. Further, the edge video stream processing described reduces the computations required at an edge device, meaning that one edge device, for instance, an edge server, can serve more than one video stream input, depending on the application. With one or more encryption levels, the confidential part of the image data can be well protected.

Those skilled in the art will note that described herein are computer-implemented methods, computer systems, and computer program products for securing confidential parts of image data in a video stream, while optimizing video transmission from an edge device to, for instance, a remote artificial intelligence (AI) processing server for performing further analytics on the image data. In one embodiment, the computer-implemented method includes pairing an edge device with one or more remote processing servers, such as one or more AI processing servers, and deploying a pretrained autoencoder deep learning model on both the edge device and the one or more remote processing servers, with encode layers at the edge device, and decode layers at the processing server. Further, the computer-implemented method includes deploying a pretrained semantic partition layer at the edge device, to partition image content of a video stream into a confidential part and a non-confidential part, and one or more encryption/decryption keys to encrypt the confidential part of the image data. Further, the method includes reading, by the edge device, a raw video stream to the semantic partition layer, and generating a non-confidential part and a confidential part of the image data from the video stream, and encrypting the confidential part with the encryption/decryption key. Further, the method includes receiving, by the encode layers of the edge device, encrypted image content and non-encrypted image content for encoding into a single encoded video stream to be transmitted to the artificial intelligence (AI) processing server(s). Further, the computer-implemented method includes transmitting, by the edge device, the single encoded video stream to the processing server(s) for decoding by the processing server, the encoded video stream to the non-confidential part and the confidential part, and using pre-deployed encryption/decryption keys that match the confidential level authorized for the processing server, to allow the processing server(s) to decrypt the confidential content, and combine the two parts into the video stream at the processing server(s) for, for instance, performing further analytics on the video stream. In one or more embodiments, the partitioning module includes machine learning which can be trained to recognize different levels of confidentiality, and the edge device can use different encryption keys assigned to the different confidentiality levels to, for instance, support transmitting the encoded video stream to multiple AI processing servers with different security levels. In one or more embodiments, the transmitting from the edge device can be via multicasting of the encoded video stream to multiple processing servers, which have the same or different access rights to the encrypted image content.

Referring to FIG. 6, in another example, a computing environment 600 includes, for instance, a computer system 602 shown, e.g., in the form of a general-purpose computing device. Computer system 602 may include, but is not limited to, one or more processors or processing units 604 (e.g., central processing units (CPUs) and/or special-purpose processors, etc.), a memory 606 (a.k.a., system memory, main memory, main storage, central storage or storage, as examples), and one or more input/output (I/O) interfaces 608, coupled to one another via one or more buses and/or other connections. For instance, processors 604 and memory 606 are coupled to I/O interfaces 608 via one or more buses 610, and processors 604 are coupled to one another via one or more buses 611.

Bus 611 is, for instance, a memory or cache coherence bus, and bus 610 represents one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and the Peripheral Component Interconnect (PCI).

Memory 606 may include, for instance, a cache 112, such as a shared cache, which may be coupled to local caches 614 of one or more processors 604 via, e.g., one or more buses 611. Further, memory 606 may include one or more programs or applications 616, at least one operating system 618, and video stream processing code 200, which implements, and/or is used in accordance with, one or more aspects of the present invention, as well as one or more computer readable program instructions 622. Computer readable program instructions 622 may be configured to carry out functions of embodiments of aspects of the invention.

Computer system 602 may communicate via, e.g., I/O interfaces 608 with one or more external devices 630, such as a user terminal, a tape drive, a pointing device, a display, and one or more data storage devices 634, etc. A data storage device 634 may store one or more programs 636, one or more computer readable program instructions 638, and/or data, etc. The computer readable program instructions may be configured to carry out functions of embodiments of aspects of the invention.

Computer system 602 may also communicate via, e.g., I/O interfaces 608 with network interface 632, which enables computer system 602 to communicate with one or more networks, such as a local area network (LAN), a general wide area network (WAN), and/or a public network (e.g., the Internet), providing communication with other computing devices or systems.

Computer system 602 may include and/or be coupled to removable/non-removable, volatile/non-volatile computer system storage media. For example, it may include and/or be coupled to a non-removable, non-volatile magnetic media (typically called a “hard drive”), a magnetic disk drive for reading from and writing to a removable, non-volatile magnetic disk (e.g., a “floppy disk”), and/or an optical disk drive for reading from or writing to a removable, non-volatile optical disk, such as a CD-ROM, DVD-ROM or other optical media. It should be understood that other hardware and/or software components could be used in conjunction with computer system 602. Examples, include, but are not limited to: microcode, device drivers, redundant processing units, external disk drive arrays, RAID systems, tape drives, and data archival storage systems, etc.

Computer system 602 may be operational with numerous other general-purpose or special purpose computing system environments or configurations. Examples of well-known computing systems, environments, and/or configurations that may be suitable for use with computer system 602 include, but are not limited to, personal computer (PC) systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computing environments described herein are only examples of computing environments that can be used. Other environments, including but not limited to, non-partitioned environments, partitioned environments, cloud environments, distributed environments, non-distributed environments, virtual environments and/or emulated environments, may be used; embodiments are not limited to any one environment. Although various examples of computing environments are described herein, one or more aspects of the present invention may be used with many types of environments. The computing environments provided herein are only examples.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more aspects of one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, additional, fewer and/or other features, constraints, tasks and/or events may be considered. Many variations are possible.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
obtaining, by an edge device, a video stream;
partitioning, by the edge device, image content of the video stream into a confidential part and a non-confidential part;
encrypting, by the edge device, the confidential part of the image content to obtain encrypted image content from the confidential part and non-encrypted image content from the non-confidential part of the image content;
encoding, by the edge device, the encrypted image content and the non-encrypted image content into an encoded video stream; and
transmitting, by the edge device, the encoded video stream to one or more processing servers.

2. The computer-implemented method of claim 1, wherein the edge device comprises a machine-learning-based partitioning layer to partition the image content of the video stream into the confidential part and the non-confidential part based on identifying one or more confidential objects in the image content of the video stream.

3. The computer-implemented method of claim 2, further comprising masking the one or more confidential objects in the image content of the video stream to produce the non-encrypted image content from the non-confidential part of the image content.

4. The computer-implemented method of claim 1, wherein the transmitting comprises multicasting, by the edge device, the encoded video stream to multiple processing servers with different access rights to the encrypted image content of the encoded video stream.

5. The computer-implemented method of claim 4, wherein the encrypting comprises separating the confidential part of the image content into multiple levels of confidential content, and separately encrypting the multiple levels of confidential content using different confidential-level encryption keys to obtain multiple levels of confidential encrypted image content.

6. The computer-implemented method of claim 4, wherein the multiple processing servers with different access rights to the encrypted image content of the encoded video stream comprise different keys to decrypt a respective level of encrypted confidential content in the encoded video stream.

7. The computer-implemented method of claim 1, wherein the edge device comprises one or more encode layers of an autoencoder, the encoding, by the edge device, being performed via the one or more encode layers of the autoencoder to provide a single encoded video stream from the encrypted image content and the non-encrypted image content.

8. The computer-implemented method of claim 7, wherein a processing server of the one or more processing servers includes one or more decode layers of the autoencoder to facilitate reconstructing at least the non-encrypted image content from the single encoded video stream.

9. The computer-implemented method of claim 1, wherein the encoding comprising using, by the edge device, lossy video compression to encode the encrypted image content and the non-encrypted image content into the encoded video stream.

10. A computer system comprising:
a memory; and
at least one processor in communication with the memory, wherein the computer system is configured to perform a method, the method comprising:
obtaining, at an edge of the computing environment, a video stream;
partitioning, at the edge of the computing environment, image content of the video stream into a confidential part and a non-confidential part;
encrypting, at the edge of the computing environment, the confidential part of the image content to obtain encrypted image content from the confidential part and non-encrypted image content from the non-confidential part of the image content;
encoding, at the edge of the computing environment, the encrypted image content and the non-encrypted image content into an encoded video stream; and
transmitting, from the edge of the computing environment, the encoded video stream to one or more processing servers of the computing environment.

11. The computer system of claim 10, wherein the partitioning utilizes a machine learning-based partition layer to partition the image content of the video stream into the confidential part and the non-confidential part based on identifying one or more confidential objects in the image content of the view stream.

12. The computer system of claim 11, further comprising masking the one or more confidential objects in the image content of the video stream to produce the non-encrypted image content from the non-confidential part of the image content.

13. The computer system of claim 10, wherein the transmitting comprises multicasting, from the edge of the computing environment, the encoded video stream to multiple processing servers with different access rights to the encrypted image content of the encoded video stream.

14. The computer system of claim 13, wherein the encrypting comprises separating the confidential part of the image content into multiple levels of confidential content, and separately encrypting the multiple levels of confidential content using different confidential-level encryption keys to obtain multiple levels of confidential encrypted image content.

15. The computer system of claim 13, wherein the multiple processing servers with different access rights to the encrypted image content of the encoded video stream comprise different keys to decrypt a respective level of encrypted confidential content in the encoded video stream.

16. The computer system of claim 10, wherein the encoding is performed via the one or more encode layers of an autoencoder to provide a single encoded video stream from the encrypted image content and the non-encrypted image content.

17. A computer program product comprising:
one or more computer readable storage media and program instructions collectively stored on the one or more computer readable storage media to perform a method comprising:
obtaining, by an edge device of the computing environment, a video stream;
partitioning, by the edge device, image content of the video stream into a confidential part and a non-confidential part;
encrypting, by the edge device, the confidential part of the image content to obtain encrypted image content from the confidential part and non-encrypted image content from the non-confidential part of the image content;
encoding, by the edge device, the encrypted image content and the non-encrypted image content into an encoded video stream; and
transmitting, by the edge device, the encoded video stream to one or more processing servers.

18. The computer program product of claim 17, wherein the partitioning comprises using a machine-learning-based partitioning layer to partition the image content of the video stream into the confidential part and the non-confidential part based on identifying one or more confidential objects in the image content of the video stream.

19. The computer program product of claim 18, further comprising masking the one or more confidential objects in the image content of the video stream to produce the non-encrypted image content from the non-confidential part of the image content.

20. The computer program product of claim 17, wherein the transmitting comprises multicasting, by the edge device, the encoded video stream to multiple processing servers with different access rights to the encrypted image content of the encoded video stream.
